(19) United States
(12) Patent Application Publication
(10) Pub. No.: US 2011/0100667 A1
(43) Pub. Date: May 5, 2011

(54) AUDIO CABLE WITH VIBRATION REDUCTION

(76) Inventor: Peter Hardie, Auckland (NZ)

(21) Appl. No.: 12/939,114

(22) Filed: Nov. 3, 2010

(30) Foreign Application Priority Data
Nov. 4, 2009 (NZ) 580946

(51) Int. Cl. H01B 7/00; H01R 43/00

(52) U.S. Cl. 174/24; 29/857

(57) ABSTRACT

A cable includes a conductor, a sheath surrounding the conductor, and a plurality of particles disposed between the conductor and the sheath. A plurality of air gaps are formed between the plurality of particles.

### RELATED APPLICATIONS

The present application claims the benefit of New Zealand Provisional Patent Number 580946, filed Nov. 4, 2009, naming Peter Hardie as the inventor. This application is incorporated herein by reference in its entirety and for all purposes.

### BACKGROUND OF THE INVENTION

Innovations in cable technology have produced commercial products with various signal transmission characteristics. Manufacturing methods and materials have been introduced to eliminate a variety of negative signal traits created when using metal cables.

Basic innovations, such as protecting the conductive material with a sheath to provide insulation have led to other improvements such as the addition of layers between the sheath and the conductor.

Further improvements have been made such as surrounding the cable's core with dielectric materials to maintain signal integrity. Various embodiments include nylon, cotton, pulverized glass, pressed siliceous stones, or asbestos. For example, a typical cable might include a solid core of copper with a layer of nylon surrounded by a plastic coating.

Additional layers have been introduced to further improve functionality for specialized purposes. For example, an additional layer of metal or a layer of braided metal can provide shielding. Other examples include a layer for abrasion resistance or a spray-on color coating for cosmetic or organizational purposes.

Further innovations include the development of mineral insulated metal sheathing (MIMS) cables whereby the conductor is insulated by inorganic magnesium oxide powder and sheathed with an outer metal layer. The inner powder is pressed and provides passive fire protection as well as being highly resistant to ionizing radiation.

Various sheath improvements can also provide a combination of flexibility, reinforcement or mechanical robustness.

Looking toward the signal, other improvements have been made to augment the bandwidth of cables. For example, twisting a pair of individually insulated wires may reduce electromagnetic interference (EMI), thereby potentially improving signal transfer efficiency.

In regard to the conductive material within the cable, innovations such as hollow conductors have been developed to reduce skin effect. Other cables may feature a core of stranded conductive materials such as braided copper or a group of individually insulated braided wires. Regarding cables, skin effect is the tendency of an alternating electric current to distribute itself within a conductor so that the current density near the surface of the conductor is greater than that at its core.

For further information concerning the structure and operation of such cables, reference may be made to U.S. Pat. Nos.: 2,787,656; 3,238,477; 4,079,192; 4,515,826; and 4,587,133.

Approaches to cable development have also been introduced to reduce or eliminate the microphonic effect. Regarding cables, the microphonic effect is caused when the cable components cause vibrations which give rise to disturbing currents of similar frequencies, which are then superimposed on the useful currents or modulate them. U.S. Pat. No. 4,920,233 describes an attempt to overcome this effect using a “series of axially aligned ferrite sleeves.” However, it would be beneficial to reduce microphonic effect without the use of magnetism.

### SUMMARY OF THE INVENTION

A cable may transmit audio signals with reduced interaction between electrical systems and/or acoustical systems. Vibration within the cable and/or the cable core may be reduced, thereby increasing fidelity, reducing distortion, microphonic effect, transmission loss, or some combination thereof.

In one embodiment, a non-conductive airtight hollow tube may be used as a sheath or covering to enclose an elongated solid cylindrical core. The core can be made from copper to form a wire. The wire may be used to create a conductor in the center of the cable. Particles or spheres may surround the core, where the spheres may be disposed between the core and the outer sheath. The spheres may be made of ceramic and/or may be hollow.

In one embodiment, particles (e.g., ceramic spheres) may be used which are approximately 70 percent air by volume. In other embodiments, particles with other ratios of air to material may be utilized.

The particles (e.g., ceramic spheres) may be introduced into the tube in a way that allows for the particles to move in relation to each other. This provides improved flexibility and allows for spaces between the particles. This use of non-compacted particles (e.g., spheres, pellets, micro-particles, etc.) may provide reduced vibration. Air may be allowed to remain in the spaces between the particles to provide insulation.

In one embodiment, the spheres may be approximately 90 microns in diameter. In one embodiment, micro-particles may be used. In other embodiments, larger or smaller spheres may be used. And in one embodiment, a variety of different sized spheres may be utilized to create a non-uniform distribution of air pockets within the cable.

The particles or spheres may be made from a vibration damping material. In one embodiment, the particles or spheres may be made from glass, plastic or another material (e.g., Teflon, etc.). The particles may be individually hollow or solid. The particles may be formed or shaped as spheres, pellets, etc. In one embodiment, the particles may be able to withstand high temperatures. And in one embodiment, the particles may be suitable for use with high and low voltage signals.

In on embodiment, the core may be constructed of a different material (e.g., a metal other than copper) and/or another type of conductor. The core may include one or more insulated strands of conductive material. It is also contemplated that the conductor may be flat. The core may be constructed with one or more fiber optic cables in one embodiment.

In one embodiment, the core may be made of a combination of metals and nonmetals. The core may be stranded or solid in one embodiment. The core may vary in diameter along its length. The core may include tinsel. And in one embodiment, the core may be magnetic.

In one embodiment, the sheath may include at least one additional layer. The at least one additional layer may include metallic foil, metallic braid, ferrite, a braided material (e.g., braided metal), some combination thereof, etc. In one embodiment, the at least one additional layer of sheath 8 may include a plurality of interconnected layers. And in one embodiment, the sheath may be formed in a shape other than a circle (e.g., a square, a triangle, a parallelogram, another shape, etc.).

In one embodiment, at least a portion of the air between the sheath and the core may be removed to create a vacuum. In one embodiment, the cable may include one or more of the layers functioning as a ground return path and/or connected to a ground return.

Embodiments of the present invention may be used in one or more applications to provide vibration damping and/or isolation (e.g., when used in combination with other componentry). For example, the cable may be coiled and used to provide a mount or footer for components (e.g., at least one vacuum tube, at least one substrate, at least one transformer, at least one speaker, at least one microphone, at least one circuit board, at least one gasket, etc.). The cable sheath may be constructed of fiberglass with inner layers of non-compacted beaded Polyvinyl chloride (PVC). In one embodiment, the cable may coiled and/or implement a spring used to provide a mount or footer for componentry. And in one embodiment, the cable may implement a rod to suspend componentry as a bob in a pendulum-type configuration.

In one embodiment, the cable may be utilized in other applications which would benefit from vibration damping and/or isolation. For example, the cable may be used to implement a speaker mount or stand, a microphone mount or stand, etc.

In one embodiment, a panel may be created by filling an open cell alloy panel with particles (e.g., beads, pellets, micro-particles, etc.). The panel may be used to implement a speaker enclosure in one embodiment.

### BRIEF DESCRIPTION OF THE DRAWINGS

Further aspects of the present invention will become apparent from the following description which is given by way of example only and with reference to the accompanying drawings.

FIG. 1 shows a cable in accordance with one embodiment of the present invention.

FIG. 2 shows a cable coupled with at least one connector in accordance with one embodiment of the present invention.

FIG. 3 shows a flowchart of an exemplary process for manufacturing a cable in accordance with one embodiment of the present invention.

### DETAILED DESCRIPTION OF THE INVENTION

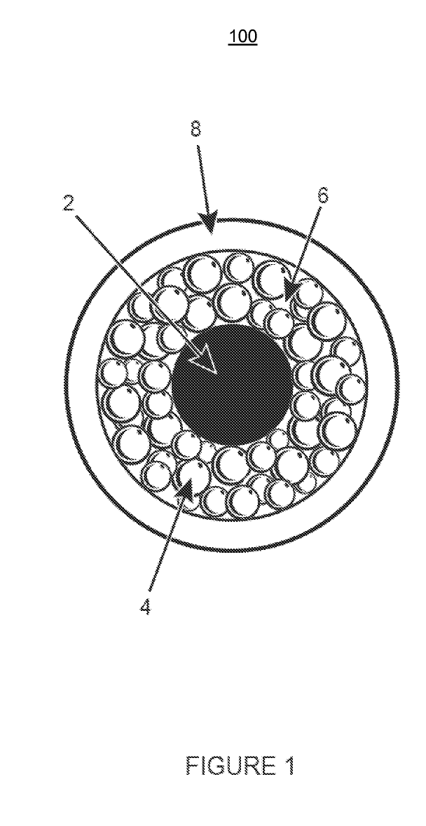

FIG. 1 shows cable 100 in accordance with one embodiment of the present invention. As shown in FIG. 1, conductor 2 may be surrounded by particles 4. Sheath 8 may surround particles 4 and conductor 2. Air gaps 6 may be disposed between particles 4, conductor 2, sheath 8, or some combination thereof. The combination of the particles 4 and air gaps 6 may operate as a dielectric to electrically isolate and/or electrically insulate conductor 2. In one embodiment, particles 4 and air gaps 6 may form a layer which can provide vibration damping, vibration isolation, impact resistance, some combination thereof, etc.

In one embodiment, particles 4 may be beads. Particles 4 may be made of ceramic in one embodiment. Particles 4 may be non-compacted (e.g., during manufacturing of the cable) to allow air gaps 6 to form. Sheath 8 may be formed of plastic (e.g., food-grade PVC, another type of plastic, etc.) tubing in one embodiment.

In one embodiment, particles 4 may be advantageously separate from (e.g., not embedded in, not combined with, etc.) sheath 8 and/or conductor 2, and therefore, particles 4 may be able to move with respect to sheath 8 and/or conductor 2. As such, cable 100 may provide increased efficiency in vibration energy conversion and/or increased flexibility. In one embodiment, particles 4 may be advantageously not compacted to increase the flexibility of cable 100, to increase efficiency in vibration energy conversion, to increase vibration damping and/or isolation, to increase electrical insulation and/or isolation, some combination thereof, etc.

In one embodiment, conductor 2 may be solid. Alternatively, conductor 2 may be stranded (e.g., include a plurality of strands or wires). In one embodiment, each stand of conductor 2 may be separately insulated. In one embodiment, conductor 2 may include at least two wires or conductors with different diameters. And in one embodiment, conductor 2 may include at least one wire or conductor with a diameter that varies along its length.

In one embodiment, conductor 2 may be round (e.g., in cross section). In one embodiment, conductor 2 may be flat (e.g., in cross section). And in one embodiment, conductor 2 may have another shape.

Conductor 2 may be made of copper in one embodiment. In one embodiment, conductor 2 may be made of a metal other than copper. And in one embodiment, conductor 2 may include tinsel, a magnetic material, some other material, etc.

In one embodiment, sheath 8 may be subdivided into compartments which restrict the movement of particles 4. In one embodiment, spacers may be disposed between conductor 2 and sheath 8 to separate particles 4 into a plurality of sections.

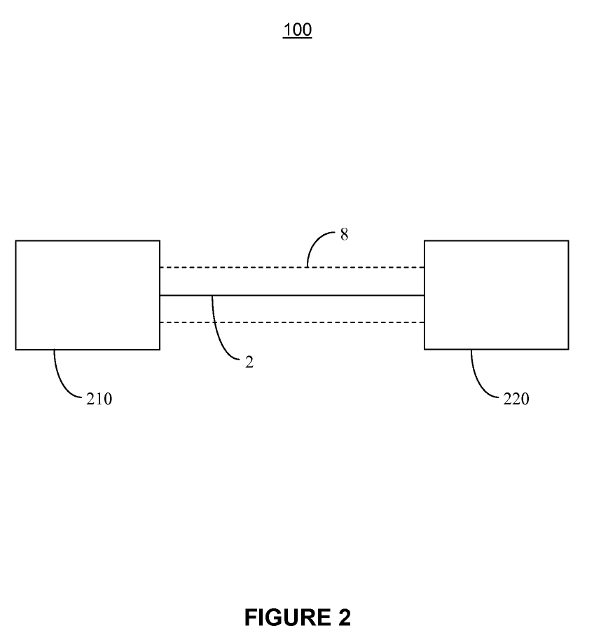

FIG. 2 shows cable 100 coupled with at least one connector or terminator in accordance with one embodiment of the present invention. As shown in FIG. 2, connector 210 and connector 220 may be coupled with or attached to conductor 2. Connector 210 and/or connector 220 may enable cable 100 to electrically couple at least two components (e.g., audio components, vacuum tubes, substrates, transformers, speakers, microphones, circuit boards, gaskets, etc.) to one another.

In one embodiment, connector 210 and/or connector 220 may be an industry-standard connector. And in one embodiment, connector 210 and/or connector 220 may be rotatable with respect to a component of cable 100 (e.g., conductor 2, particles 4, sheath 8, etc.).

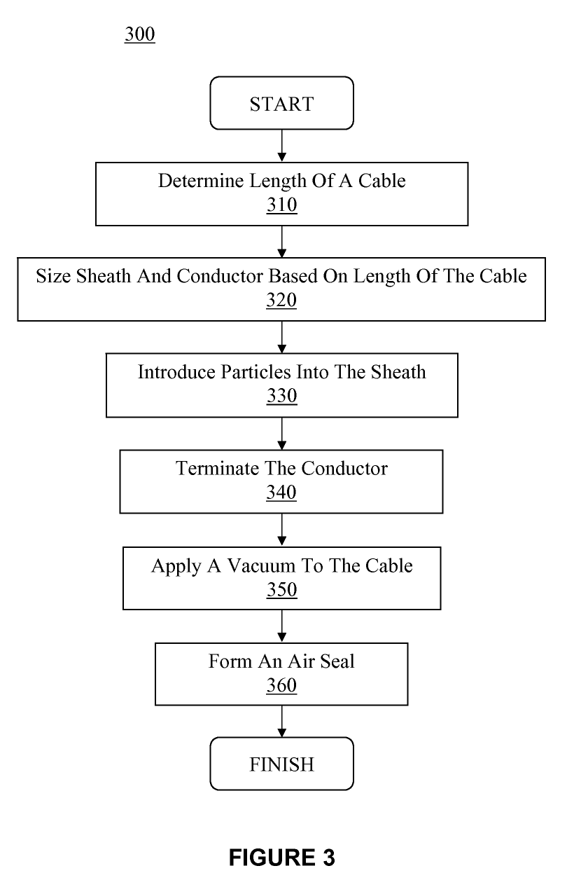

FIG. 3 shows a flowchart of exemplary process 300 for manufacturing a cable in accordance with one embodiment of the present invention. As shown in FIG. 3, step 310 involves determining the length of cable 100. Step 320 involves sizing conductor 2 and/or sheath 8 based upon the determined length of cable 100. Step 320 may involve cutting conductor 2 and/or sheath 8 to a predetermined length (e.g., based upon the length of cable 100 determined in step 310).

Step 330 involves introducing particles into the sheath. For example, particles 4 may be introduced into sheath 8 such that they surround conductor 2. Step 330 may involve introducing the particles (e.g., 4) such that air gaps (e.g., 6) are formed between the particles (e.g., 4).

As shown in FIG. 3, step 340 involves terminating the conductor. In one embodiment, conductor 2 may be terminated by attaching at least one terminator or connector (e.g., 210, 220, etc.) to conductor 2. Step 340 may involve polishing an end of conductor 2 and/or removing a coating from an end of conductor 2 prior to the attachment of a terminator or connector (e.g., 210, 220, etc.).

Step 350 involves applying a vacuum to cable 100. The vacuum may remove air from between sheath 8 and conductor 2 to encapsulate particles 4 and/or increase a parameter (e.g., vibration damping, vibration isolation, electrical insulation, electrical isolation, etc.) of cable 100.

As shown in FIG. 3, step 360 involves forming an air seal (e.g., between sheath 8, conductor 2, connector 210, connector 220, some combination thereof, etc.). The air seal may reduce an ability of air or other matter (e.g., dirt, contaminants, etc.) to enter the region between sheath 8 and conductor 2.

Turning back to FIGS. 1 and 2, Teflon may be used as conductor insulators for cable 100 to maintain and/or increase signal fidelity. For example, cable 100 may produce cleaner transient information, increased high frequency clarity, reduced dynamic peak compression, some combination thereof, etc.

In one embodiment, cable 100 may reduce attenuation created by conductor 2. In this manner, cable 100 may reduce electromagnetic interference (EMI) emissions.

Cable 100 may have a reduced material count compared to conventional cables. As such, one or more benefits associated with manufacturing may be realized. Additionally, the reduced material count may increase the compactness and/or flexibility of cable 100 compared with conventional cables.

In one embodiment, cable 100 may provide low dielectric loss and/or low capacitance insulation. In one embodiment, particles 4 and air gaps 6 may form a layer which can provide electrical isolation, electrical insulation, vibration damping, vibration isolation, impact resistance, some combination thereof, etc. Cable 100 may be relatively lightweight in one embodiment. And in on embodiment, particles 4 and air gaps 6 may form a non-compacted dielectric which can improve signal fidelity.

Although FIGS. 1 and 2 show components of cable 100 with a specific size and shape, it should be appreciated that other sizes and/or shapes of components may be used in cable 100 in other embodiments. And although FIGS. 1 and 2 show a specific number of components of cable 100, it should be appreciated that a different number of components of cable 100 may be used in cable 100 in other embodiments.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A cable comprising:
a conductor;
a sheath surrounding said conductor; and
a plurality of particles disposed between said conductor and said sheath, wherein a plurality of air gaps are formed between said plurality of particles.

2. The cable of claim 1, wherein said plurality of particles are operable to move relative to said conductor and said sheath.

3. The cable of claim 1, wherein said conductor is selected from a group consisting of a solid conductor, a plurality of stranded conductors, a plurality of stranded and separately insulated conductors, at least two wires with different diameters, and at least one wire with a diameter that varies along its length, a round conductor, a flat conductor, a copper conductor, a metallic conductor, a tinsel conductor, and a magnetic conductor.

4. The cable of claim 1, wherein said sheath has a shape selected from a group consisting of a circle, a square, a triangle, a parallelogram, and another shape.

5. The cable of claim 1, wherein said sheath further comprises at least one additional layer selected from a group consisting of metallic foil, metallic braid, ferrite, and a braided material.

6. The cable of claim 1, wherein said plurality of particles are selected from a group consisting of spherical particles, pellets, micro-particles, solid particles, and hollow particles.

7. The cable of claim 1, wherein said plurality of particles are made from a material selected from a group consisting of a vibration damping material, glass, plastic, and another type of material.

8. The cable of claim 1, wherein said plurality of particles comprises a first particle of a first size and a second particle of a second size.

9. A cable comprising:
a conductor;
a sheath surrounding said conductor;
a plurality of particles disposed between said conductor and said sheath, wherein a plurality of air gaps are formed between said plurality of particles; and
at least one connector coupled with said conductor.

10. The cable of claim 9, wherein an air seal is formed between said sheath and said at least one connector.

11. The cable of claim 9, wherein said plurality of particles are operable to move relative to said conductor and said sheath.

12. The cable of claim 9, wherein said conductor is selected from a group consisting of a solid conductor, a plurality of stranded conductors, a plurality of stranded and separately insulated conductors, at least two wires with different diameters, and at least one wire with a diameter that varies along its length, a round conductor, a flat conductor, a copper conductor, a metallic conductor, a tinsel conductor, and a magnetic conductor.

13. The cable of claim 9, wherein said sheath has a shape selected from a group consisting of a circle, a square, a triangle, a parallelogram, and another shape.

14. The cable of claim 9, wherein said sheath further comprises at least one additional layer selected from a group consisting of metallic foil, metallic braid, ferrite, and a braided material.

15. The cable of claim 9, wherein said plurality of particles are selected from a group consisting of spherical particles, pellets, micro-particles, solid particles, and hollow particles.

16. The cable of claim 9, wherein said plurality of particles are made from a material selected from a group consisting of a vibration damping material, glass, plastic, and another type of material.

17. The cable of claim 9, wherein said plurality of particles comprises a first particle of a first size and a second particle of a second size.

18. A method of manufacturing a cable, said method comprising:
introducing a plurality of particles between a sheath and a conductor, wherein said sheath surrounds said conductor, and wherein a plurality of air gaps are formed between said plurality of particles; and
attaching at least one connector to said conductor.

19. The method of claim 18 further comprising:
cutting said conductor and said sheath to a predetermined length.

20. The method of claim 18, wherein said attaching further comprises performing an operation selected from a group consisting of polishing an end of said conductor and removing a coating from an end of said conductor.

21. The method of claim 18 further comprising:
forming an air seal between said sheath and said at least one connector.

22. The method of claim 18, wherein said plurality of particles are operable to move relative to said conductor and said sheath.

23. The method of claim 18, wherein said conductor is selected from a group consisting of a solid conductor, a plurality of stranded conductors, a plurality of stranded and separately insulated conductors, at least two wires with different diameters, and at least one wire with a diameter that varies along its length, a round conductor, a flat conductor, a copper conductor, a metallic conductor, a tinsel conductor, and a magnetic conductor.

24. The method of claim 18, wherein said sheath further comprises at least one additional layer selected from a group consisting of metallic foil, metallic braid, ferrite, and a braided material.

25. The method of claim 18, wherein said plurality of particles are selected from a group consisting of spherical particles, pellets, micro-particles, solid particles, and hollow particles, wherein said plurality of particles are made from a material selected from a group consisting of a vibration damping material, glass, plastic, and another type of material, and wherein said plurality of particles comprises a first particle of a first size and a second particle of a second size.
